(19) United States
(12) Patent Application Publication
(10) Pub. No.: US 2009/0075671 A1
(43) Pub. Date: Mar. 19, 2009

(54) Method and device for changing method for determining position of mobile station within mobile communication network

(76) Inventors: Jean-Christophe Dupuy, Le Cannet (DE); Guillaume Blanc, Peymainade (FR)

Correspondence Address: STAAS & HALSEY LLP, SUITE 700, 1201 NEW YORK AVENUE, N.W., WASHINGTON, DC, 20005, US

(21) Appl. No.: 11/988,726

(22) PCT Filed: Jun. 23, 2006
(86) PCT No.: PCT/EP2006/063513

§ 371 Date: Jan. 14, 2008

(30) Foreign Application Priority Data
Jul. 14, 2005 (DE) 10-2005-032.943.8

(51) Int. Cl. H04W 4/02

(52) U.S. Cl. 455/456.1

(57) ABSTRACT

After a method is carried out for determining the position of a mobile station within a mobile communication network, characteristic information on the method and context is stored in a database. Then, the stored information is evaluated and the method is modified by adapting the method or by selecting another method for determining the position using the evaluation results of the stored information. These operations can be repeated as needed.

### CROSS REFERENCE TO RELATED APPLICATIONS

This application is based on and hereby claims priority to German Application No. 10 2005 032 943.8 filed on Jul. 14, 2007, the contents of which are hereby incorporated by reference.

### BACKGROUND

Described below are a method and a device for changing a method for determining the position of a mobile station within a mobile communication network.

The determination of the position of a mobile terminal in a mobile radio network, as shown for example in FIG. 1, is the basis for a large number of new, position-based services. In this context, well defined requirements are generally made of the accuracy and the speed of the determination of the position. Nowadays, a series of different methods are available for carrying out this task, for example GPS-based methods and various methods which evaluate mobile radio measurements. The efficiency of these methods depends on various factors: on the type of method used, on the resolution and duration of the measurements, but also on the surroundings of the receiver (GPS functions less well, for example in enclosed spaces, than in the open). Under certain circumstances it is also possible for a method to fail and provide no result at all.

Standard methods for selecting the position determining method are static and are based on permanently set performance features. For example, a method is assigned a fixed accuracy and a latency time and is then selected by reference to the request. An even simpler method is to start with the best possible available method and to resort to the respectively next best method in the event of a failure. The strategies have the disadvantage that they do not make any reference to the current situation or to experience from the past and therefore in many cases waste resources and time because, for example, a method is started which actually has no prospect of succeeding.

### SUMMARY

An aspect is to specify a method and a device which selects the type and sequence of the position determining methods to be applied in such a way that the best possible result in accordance with the requirements is achieved with minimal expenditure.

Another aspect is a method for changing a method for determining the position of a mobile station within a mobile communication network.

The method includes:
(a) a method for determining the position is carried out,
(b) information which is characteristic of the method and context is stored,
(c) the stored information is evaluated, and
(d) the method is changed by adapting the method or by selecting a further method for determining the position based on an evaluation result of the stored information.

In this context, the operations (a) to (d) can be repeated.

The device carries out the method utilizing a database storing the above-mentioned information.

In the proposed method, a network node in a mobile communication network which makes the decision about the strategy for determining the position (for example SMLC or LES) is also intended to take into account “experience” from the past in addition to the static information. The information about the success or failure of a method and, if present, about the quality of the result is stored together with information about the surroundings such as, for example, the identity of the radio cell to be used or the information as to whether the mobile station is in the open or in a building. When later position requests are made under similar conditions, it is possible to resort to the information, which makes better selection of the methods possible. If, for example, it becomes apparent that “assisted GPS” very often fails in a specific cell (for example because the cell is a microcell which covers a building), it is possible from the outset to dispense with the time consuming and energy intensive GPS measurement and to resort to an alternative method. This information which can be stored in the data base brings about a situation in which the system learns how to select the optimum strategy better and better in the course of time.

Through the use of “experience” in selecting the position determining method, the process of determining the position is optimized. The expenditure on energy in the terminal and the complexity of signalling as well as the data traffic in the network are therefore reduced. At the same time, the quality of the service is increased since the average accuracy rises and the average waiting time is shortened to a valid position estimation.

### BRIEF DESCRIPTION OF THE DRAWINGS

These and other aspects and advantages will become more apparent and more readily appreciated from the following description of an exemplary embodiment, taken in conjunction with the accompanying drawings of which:

FIG. 1 is a block diagram of a mobile communication network, and

FIG. 2 is a flowchart of the method described below.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

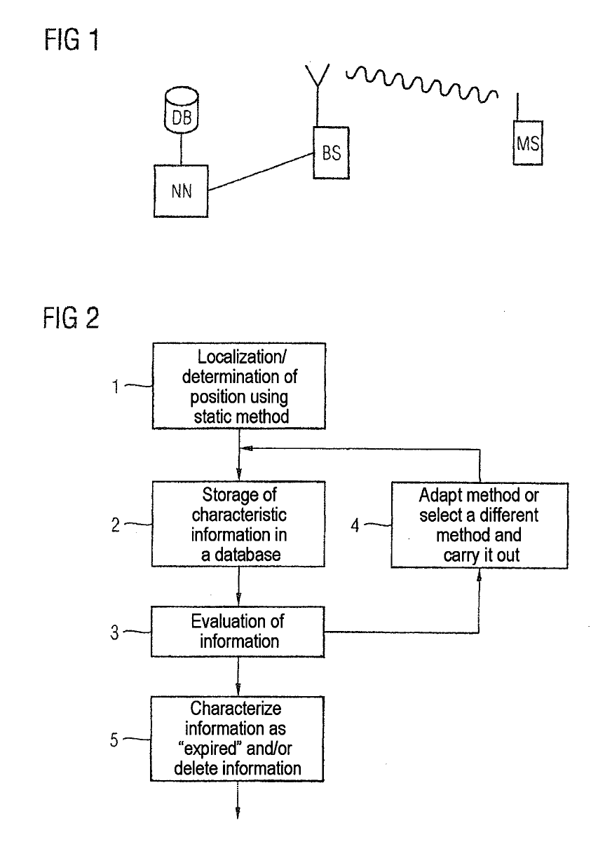

FIG. 1 is a schematic view of a mobile communication network with a mobile station MS which is connected to a base station BS via an air interface. The base station BS is connected to a network node NN of a mobile fixed network (not illustrated) wherein the network node itself maintains a database DB or is connected to such a database DB.

FIG. 2 is a flowchart of the method described below which is preferably implemented in a network node NN of the mobile communication network.

According to the operation in block 1 of FIG. 2, a method for locating or determining the position of a mobile station MS according to one of the static selection methods mentioned above will firstly be carried out. After the operation in block 2 of FIG. 2, an entry is generated in a data base DB for each result, the entry containing, for example, the following information:
identity of the radio cell to be used,
information about the mobile station as to whether it is located within or outside buildings,
for each localization method started, success or failure, estimated accuracy, time to the result being obtained as well as position determined etc.

In block 3, the information is evaluated and it is decided whether, as explained in block 4, a different method is to be selected, and after the method has been carried out the information about the newly selected method is to be stored in the data base.

This information can be evaluated periodically in order to adapt the parameters of the selection method and change them dynamically.

The accuracy and duration of a method which are achieved are accordingly a function of the radio cell and whether the mobile station is located within or outside a building. Of course, the results of successive localization processes are also stored and used to improve the selection strategy.

The data can be stored in a database or else transferred from an expert system. The fact that the surroundings change can be allowed for by taking into account the age of the information. As is shown optionally in block 5, in the simplest case the information can “expire” after a certain time and be deleted. Likewise, the information can be weighted as a function of its age.

The system also includes permanent or removable storage, such as magnetic and optical discs, RAM, ROM, etc. on which the process and data structures of the present invention can be stored and distributed. The processes can also be distributed via, for example, downloading over a network such as the Internet. The system can output the results to a display device, printer, readily accessible memory or another computer on a network.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-11. (canceled)

12. A process for changing a method for determining a position of a mobile station within a mobile communication network, comprising:
applying the method for determining the position;
storing information characteristic of the method and context;
evaluating the information previously stored; and
changing the method by one of adapting the method and selecting a different method for determining the position based on said evaluating of the information.

13. The method as claimed in claim 12, further comprising repeating said applying, storing, evaluating and changing.

14. The method as claimed in claim 12 wherein said storing stores the information in a database.

15. The method as claimed in claim 12, wherein said evaluating of the information is performed periodically.

16. The method as claimed in claim 12, wherein the information stored and evaluated includes at least one of an identity of a radio cell in which the mobile station is located when the position thereof is determined, an indication of whether the mobile station is located within or outside a building when the position thereof is determined, an indication of success or failure of the method applied for determining the position, an estimated accuracy of the position, and a time when the method for determining the position is carried out.

17. The method as claimed in claim 16, wherein said storing of the information includes an expiry date of the information that is stored.

18. The method as claimed in claim 17, further comprising deleting, after a predetermined time, the information stored.

19. The method as claimed in claim 18, further comprising weighting the information as a function of age of the information.

20. A device, within a mobile communication network, for changing a method for determining a position of a mobile station within the mobile communication network, comprising:
means for applying a method for determining the position of the mobile station;
means for storing information characteristic of the method and context;
means for evaluating the information stored to obtain an evaluation result; and
means for changing the method by one of adapting the method and selecting a different method for determining the position by reference to the evaluation result.

21. The device as claimed in claim 20, wherein the device is implemented in a network node of the mobile communication network.

22. A computer-readable medium encoded with a computer program that when executed by a processor causes a computer to perform a method for determining a position of a mobile station within a mobile communication network, said method comprising:
applying the method for determining the position;
storing information characteristic of the method and context;
evaluating the information previously stored; and
changing the method by one of adapting the method and selecting a different method for determining the position based on said evaluating of the information.
